(19) United States
(12) Patent Application Publication
(10) Pub. No.: US 2012/0252236 A1
(43) Pub. Date: Oct. 4, 2012

(54) CONNECTOR TERMINAL STRUCTURE

(75) Inventor: MING-KUNG YANG, NEW TAIPEI CITY (TW)

(73) Assignee: MAIN SUPER ENTERPRISES CO., LTD., NEW TAIPEI CITY (TW)

(21) Appl. No.: 13/248,133

(22) Filed: Sep. 29, 2011

(30) Foreign Application Priority Data
Mar. 28, 2011 (TW) 100205467

(51) Int. Cl. H01R 12/51

(52) U.S. Cl. 439/83

(57) ABSTRACT

A connector terminal structure is disclosed. The connector has a circuit board on which a first terminal set and a second terminal set are soldered. Each of the first and second terminal sets includes multiple terminals. Each terminal has a contact section and a soldered section. The contact sections of the first and second terminal sets together define a signal contact area. The connection terminal structure is characterized in that the soldered sections of the terminals of the first terminal set and the soldered points of the circuit board on which the soldered sections are soldered are positioned on a first side of the signal contact area, while the soldered sections of the terminals of the second terminal set and the soldered points of the circuit board on which the soldered sections are soldered are positioned on a second side of the signal contact area opposite to the first side.

### BACKGROUND OF THE INVENTION

1. Field of the Invention

The present invention relates to an improved connector terminal structure. The connector has a circuit board on which a first terminal set and a second terminal set are soldered. The soldered sections of the terminals of the first terminal set and the soldered points of the circuit board on which the soldered sections are soldered are positioned on a first side, while the soldered sections of the terminals of the second terminal set and the soldered points of the circuit board on which the soldered sections are soldered are positioned on a second side. Accordingly, the distance between the soldered points of the circuit board is greatly enlarged so as to minimize interference between signals with different frequencies in transmission.

2. Description of the Prior Art

FIG. 9 shows a conventional connector structure including a first terminal set 80 and a second terminal set 90. Each of the first and second terminal sets 80, 90 is composed of multiple terminals 80a, 80b, 80c, 80d and 90a, 90b, 90c, 90d, 90e. Each terminal 80a, 80b, 80c, 80d, 90a, 90b, 90c, 90d, 90e has a contact section 81, 91 and a soldered section 82, 92. The soldered sections 82, 92 are soldered on corresponding soldered points P of a circuit board 20a.

In the conventional connector structure, the soldered points P of the circuit board 20a are lined up. Therefore, the intervals between the terminals 80a, 80b, 80c, 80d, 90a, 90b, 90c, 90d, 90e of the first and second terminal sets 80, 90 are extremely small. As a result, it is hard to solder the terminals on the circuit board. Moreover, when the first and second terminal sets 80, 90 respectively transmit high-frequency and low-frequency signals, the signals often interference with each other due to too small intervals. This will affect the signal transmission quality and need to be overcome.

### SUMMARY OF THE INVENTION

It is therefore a primary object of the present invention to provide an improved connector terminal structure. The connector has a circuit board on which a first terminal set and a second terminal set are soldered. Each of the first and second terminal sets includes multiple terminals. Each terminal has a contact section and a soldered section. The contact sections of the first and second terminal sets together define a signal contact area. The connection terminal structure is characterized in that the soldered sections of the terminals of the first terminal set and the soldered points of the circuit board on which the soldered sections are soldered are positioned on a first side of the signal contact area, while the soldered sections of the terminals of the second terminal set and the soldered points of the circuit board on which the soldered sections are soldered are positioned on a second side of the signal contact area opposite to the first side. Accordingly, the distance between the soldered points of the circuit board is greatly enlarged so as to minimize interference between signals with different frequencies.

In the above connector terminal structure, the first and second terminal sets are embedded in a plastic main body. The contact sections of the terminals of the first terminal set have plane contact faces exposed to the exterior of the plastic main body. The soldered sections of the terminals of the first terminal set are respectively positioned on a first side of the plastic main body. The contact sections of the terminals of the second terminal set are in the form of a free end and respectively extending into corresponding perforations of the plastic main body to be elastically pressed and biased. The soldered sections of the terminals of the second terminal set are respectively positioned on a second side of the plastic main body opposite to the first side of the plastic main body. The terminals of the first and second terminal sets are integrally embedded in the plastic main body by means of injection molding. In the manufacturing process of the connector, the plastic main body is directly rested on the circuit board and then passed through a high-temperature area to solder the soldered sections of the terminal of the first and second terminal sets with the circuit board. It is quite convenient in manufacturing.

In the above connector terminal structure, the terminals of the first terminal set include a pair of low-frequency signal terminals, a power terminal and a grounding terminal and the second terminal set includes two pairs of high-frequency signal terminals and a grounding terminal.

In the above connector terminal structure, the distance between the soldered points of the circuit board on which the first and second terminal sets are soldered is greatly enlarged. In this case, when the first and second terminal sets transmit signals with different frequencies, the signals will not interference with each other so that the signal transmission quality is enhanced.

The present invention can be best understood through the following description and accompanying drawings, wherein:

### BRIEF DESCRIPTION OF THE DRAWINGS

FIG. 1 is a perspective view showing the arrangement of the terminals of the first and second terminal sets of the present invention;

FIG. 2 is a perspective view showing that the first and second terminal sets are embedded in the plastic main body;

FIG. 3 is a perspective exploded view of the present invention, in which the first and second terminal sets are not yet soldered on the circuit board;

FIG. 4 is a perspective view of the present invention, in which the first and second terminal sets are soldered on the circuit board and the cover board is not yet overlaid on the circuit board;

FIG. 5 is a perspective assembled view of the present invention according to FIG. 4, showing that the cover board is overlaid on the circuit board;

FIG. 6 is a perspective assembled view of the present invention according to FIG. 5, showing that the cover board and the circuit board are coated with an insulation layer;

FIG. 7 is a top view of the present invention, showing that the first and second terminal sets are soldered on the circuit board;

FIG. 8 is a top view of a second embodiment of the present invention; and

FIG. 9 is a top view of a conventional connector, showing that the first and second terminal sets are soldered on the circuit board.

### DETAILED DESCRIPTION OF THE PREFERRED EMBODIMENTS

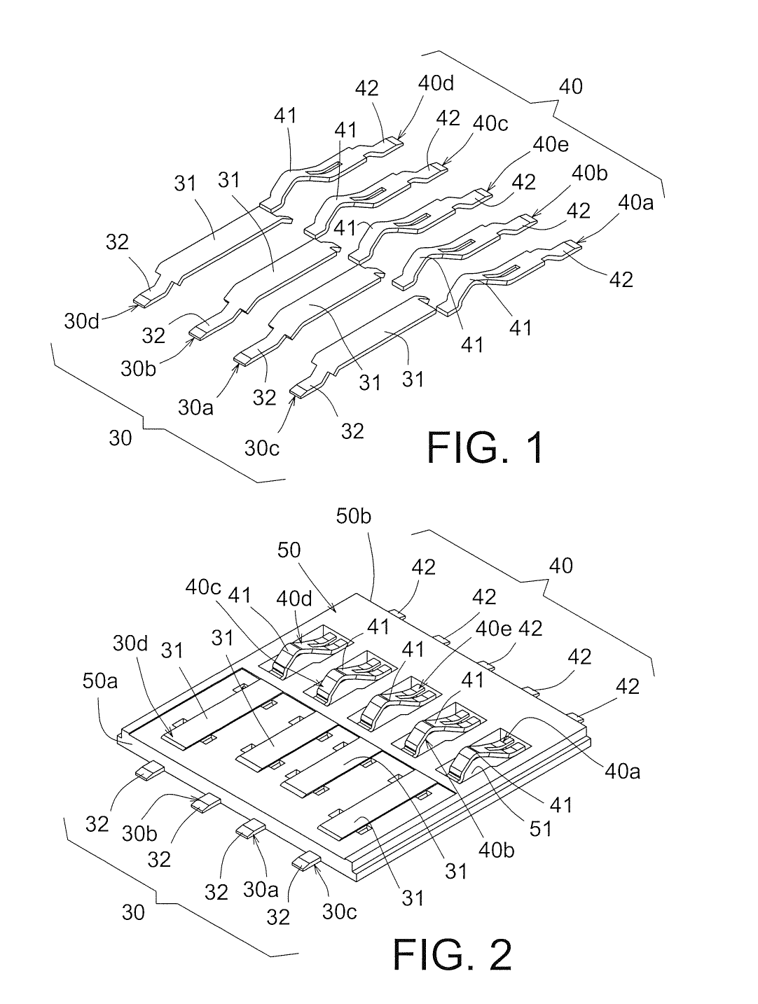

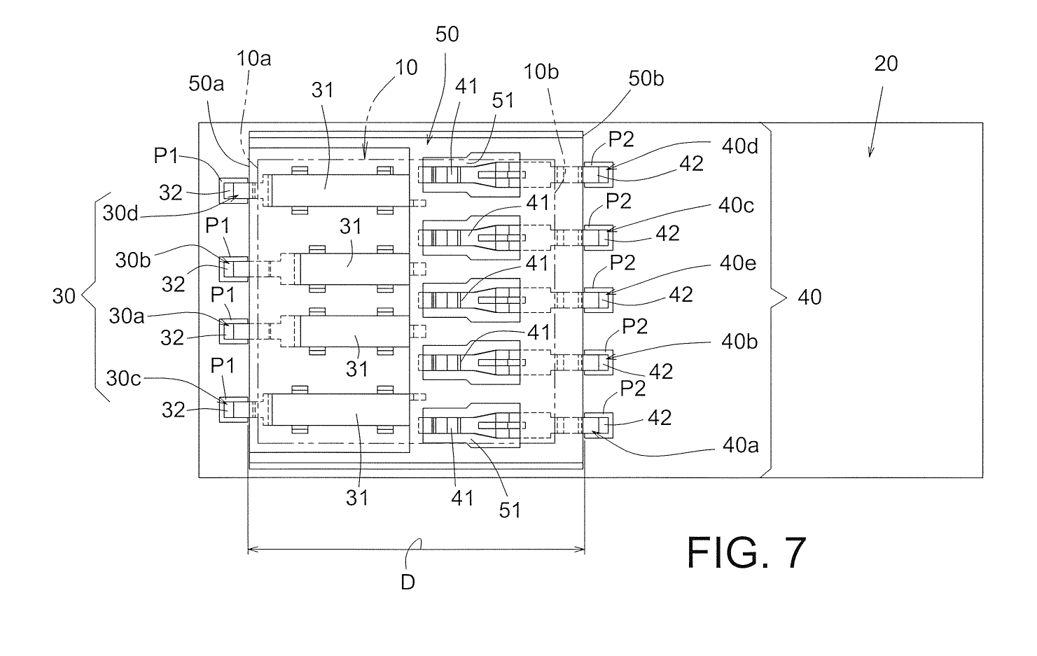

Please refer to FIGS. 1, 2, 3 and 7. The present invention relates to a connector terminal structure. The connector has a circuit board 20 on which a first terminal set 30 and a second terminal set 40 are soldered. Each of the first and second terminal sets 30, 40 includes multiple terminals 30a, 30b, 30c, 30d and 40a, 40b, 40c, 40d, 40e. Each terminal 30a, 30b, 30c, 30d, 40a, 40b, 40c, 40d, 40e has a contact section 31, 41 and a soldered section 32, 42. The contact sections 31, 41 of the first and second terminal sets 30, 40 together define a signal contact area 10 (as shown in FIG. 7). The connection terminal structure of the present invention is characterized in that the soldered sections 32 of the terminals 30a, 30b, 30c, 30d of the first terminal set 30 and the soldered points P1 of the circuit board 20 on which the soldered sections 32 are soldered are positioned on a first side 10a of the signal contact area 10, while the soldered sections 42 of the terminals 40a, 40b, 40c, 40d, 40e of the second terminal set 40 and the soldered points P2 of the circuit board 20 on which the soldered sections 42 are soldered are positioned on a second side 10b of the signal contact area 10 (opposite to the first side). Under such circumstance, the distance D between the soldered points P1, P2 of the circuit board 20 on which the first and second terminal sets 30, 40 are soldered is enlarged so as to minimize interference between signals.

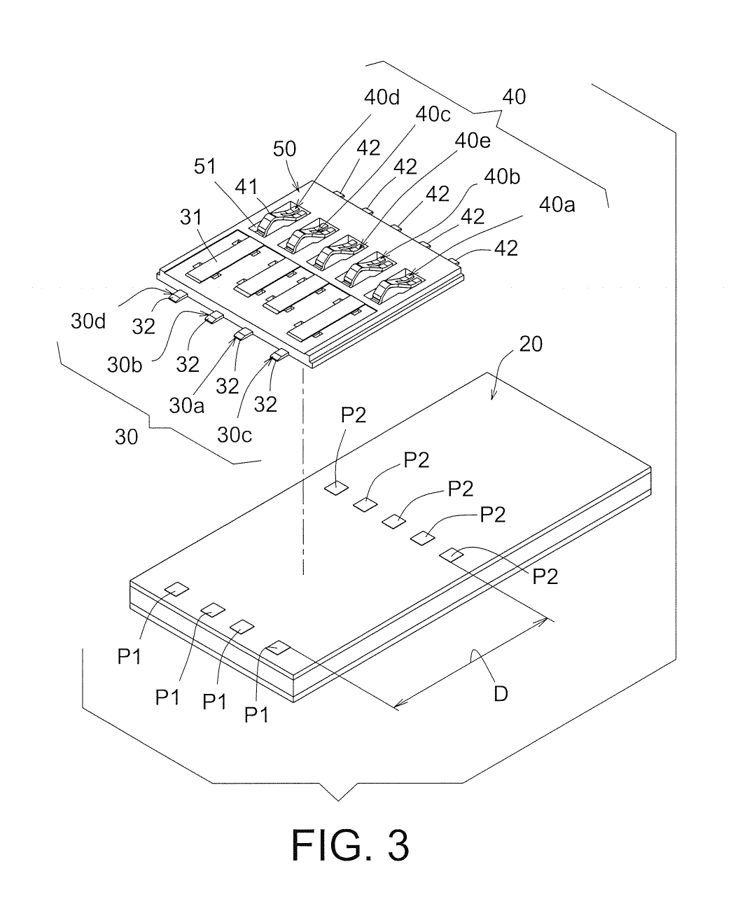

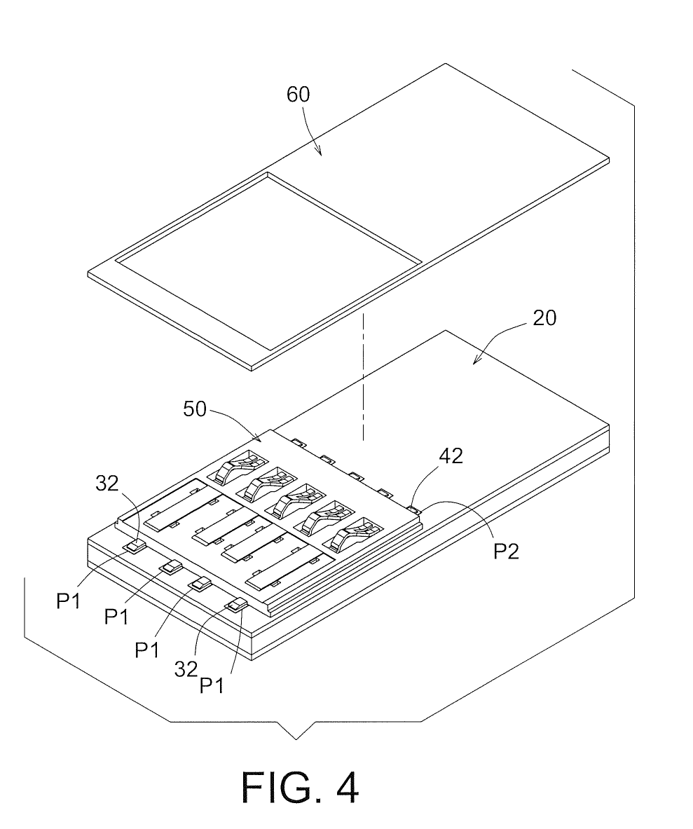

As shown in FIG. 2, the first and second terminal sets 30, 40 are embedded in a plastic main body 50. The contact sections 31 of the terminals 30a, 30b, 30c, 30d of the first terminal set 30 have plane contact faces exposed to the exterior of the plastic main body 50. The soldered sections 32 of the terminals 30a, 30b, 30c, 30d of the first terminal set 30 are respectively positioned on a first side 50a of the plastic main body 50. The contact sections 41 of the terminals 40a, 40b, 40c, 40d, 40e of the second terminal set 40 are in the form of a free end and respectively extend into corresponding perforations 51 of the plastic main body 50 to be elastically pressed and biased. The soldered sections 42 of the terminals 40a, 40b, 40c, 40d, 40e of the second terminal set 40 are respectively positioned on a second side 50b of the plastic main body 50 (opposite to the first side of the plastic main body). The terminals 30a, 30b, 30c, 30d, 40a, 40b, 40c, 40d, 40e of the first and second terminal sets 30, 40 can be integrally embedded in the plastic main body 50 by means of injection molding. As shown in FIG. 3, in the following processing, the plastic main body 50 is directly rested on the circuit board 20 and then passed through a high-temperature area to solder the soldered sections 32, 42 of the terminal 30a, 30b, 30c, 30d, 40a, 40b, 40c, 40d, 40e of the first and second terminal sets 30, 40 with the circuit board 20. It is quite convenient in manufacturing.

In the connection terminal structure of the present invention, the terminals 30a, 30b, 30c, 30d of the first terminal set 30 include a pair of low-frequency signal terminals 30a, 30b, a power terminal 30d and a grounding terminal 30c. The second terminal set 40 includes two pairs of high-frequency signal terminals 40a, 40b, 40c, 40d and a grounding terminal 40c. However, the definitions of these terminals 30a, 30b, 30c, 30d, 40a, 40b, 40c, 40d, 40e are not limited.

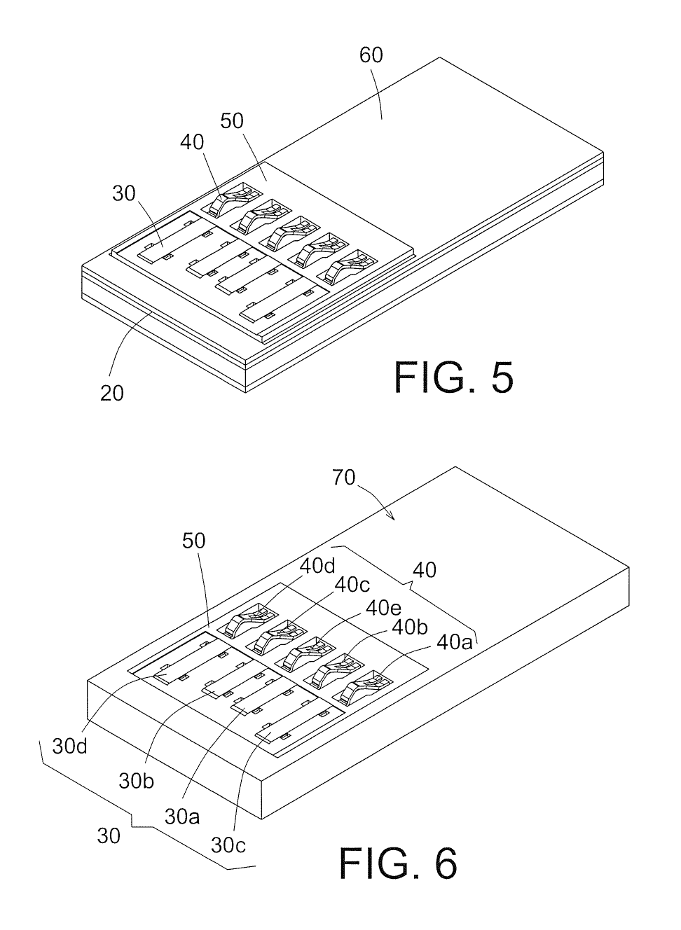

As shown in FIG. 5, in the manufacturing process of the connector terminal structure of the present invention, after the first and second terminal sets 30, 40 are soldered on the circuit board 20, a cover board 60 is overlaid on the circuit board 20. Then, as shown in FIG. 6, the cover board 60 and the circuit board 20 are coated with an insulation layer 70 by means of injection molding.

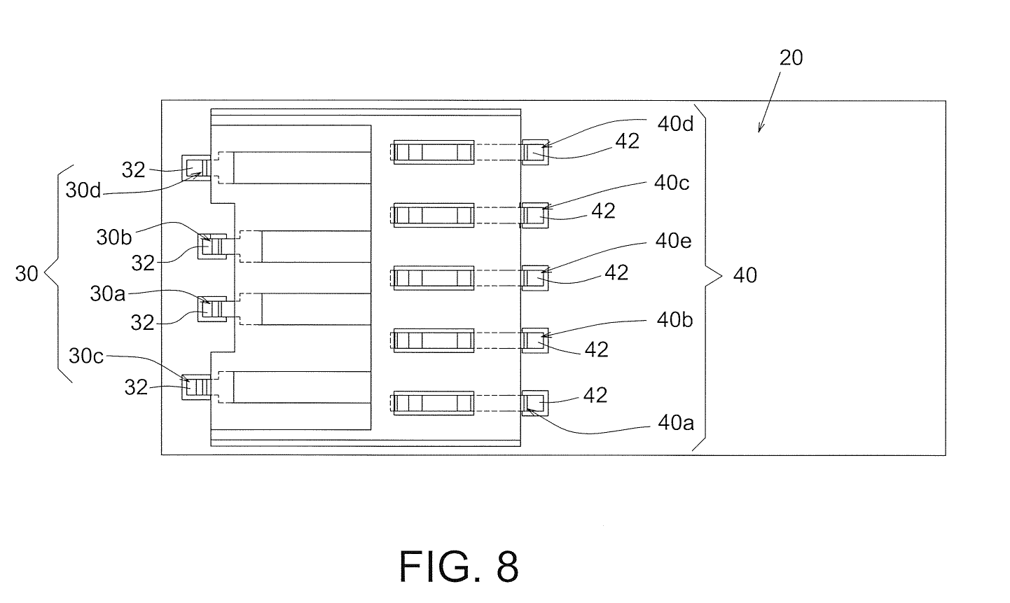

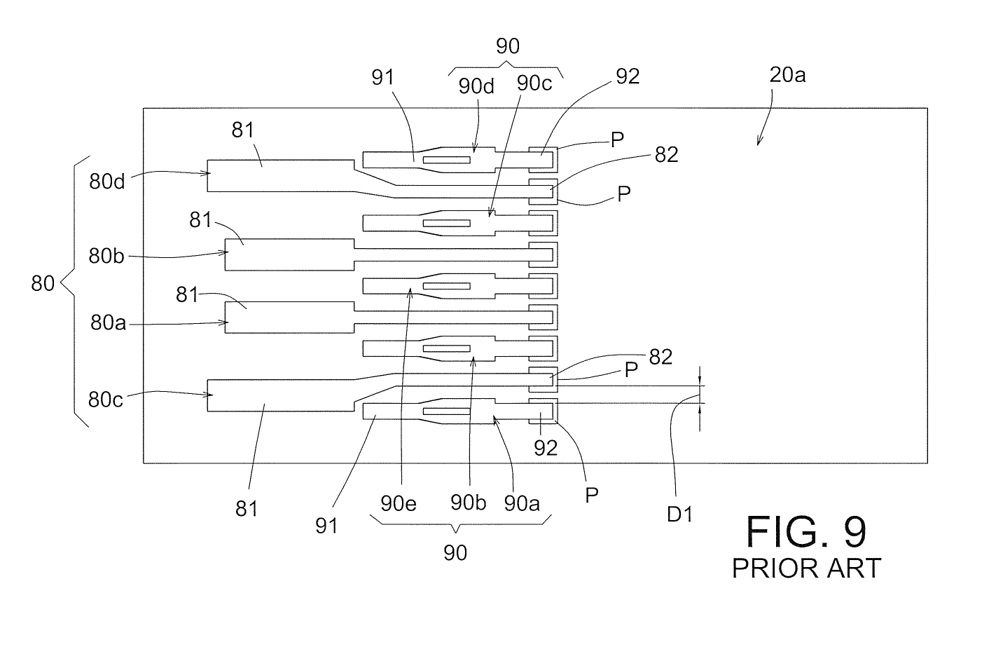

In the connector terminal structure of the present invention, the soldered sections 32, 42 of the terminals 30a, 30b, 30c, 30d, 40a, 40b, 40c, 40d, 40e of the first and second terminal sets 30, 40 can be lined up and soldered on the circuit board 20 in one row as shown in FIG. 7. Alternatively, the soldered sections 32, 42 of the terminals 30a, 30b, 30c, 30d, 40a, 40b, 40c, 40d, 40e of the first and second terminal sets 30, 40 are not lined up and are soldered on the circuit board 20 in multiple rows. As shown in FIG. 8, the soldered sections 32 of the terminals 30a, 30b, 30c, 30d of the first terminal set 30 are arranged in two rows.

Referring to FIG. 7, the connector terminal structure of the present invention is mainly characterized in that the distance D between the soldered points P1, P2 of the circuit board on which the first and second terminal sets 30, 40 are soldered is greatly enlarged. In this case, when the first and second terminal sets 30, 40 transmit signals with different frequencies, the signals will not interference with each other so that the signal transmission quality is enhanced. In addition, the soldered sections 32 of the terminals 30a, 30b, 30c, 30d of the first terminal set 30 and the soldered sections 42 of the terminals 40a, 40b, 40c, 40d, 40e of the second terminal set 40 are respectively laid out on two sides of the circuit board 20, which sides are spaced from each other by a considerable distance. Therefore, the intervals between the soldered points P1, P1 or P2, P2 are enlarged. This facilitates the soldering operation and avoids short-circuit caused by too short distance. Also, this can avoid electromagnetic interference between the terminals due to too short distance.

The above embodiments are only used to illustrate the present invention, not intended to limit the scope thereof. Many modifications of the above embodiments can be made without departing from the spirit of the present invention.

What is claimed is:

1. A connector terminal structure, the connector having a circuit board on which a first terminal set and a second terminal set are soldered, each of the first and second terminal sets including multiple terminals, each terminal having a contact section and a soldered section, the contact sections of the first and second terminal sets together defining a signal contact area, the connection terminal structure being characterized in that the soldered sections of the terminals of the first terminal set and the soldered points of the circuit board on which the soldered sections are soldered are positioned on a first side of the signal contact area, while the soldered sections of the terminals of the second terminal set and the soldered points of the circuit board on which the soldered sections are soldered are positioned on a second side of the signal contact area opposite to the first side.

2. The connector terminal structure as claimed in claim 1, wherein the first and second terminal sets are embedded in a plastic main body, the contact sections of the terminals of the first terminal set having plane contact faces exposed to the exterior of the plastic main body, the soldered sections of the terminals of the first terminal set being respectively positioned on a first side of the plastic main body, the contact sections of the terminals of the second terminal set being in the form of a free end and respectively extending into corresponding perforations of the plastic main body to be elastically pressed and biased, the soldered sections of the terminals of the second terminal set being respectively positioned on a second side of the plastic main body opposite to the first side of the plastic main body.

3. The connector terminal structure as claimed in claim 1, wherein the terminals of the first terminal set include a pair of low-frequency signal terminals, a power terminal and a grounding terminal and the second terminal set includes two pairs of high-frequency signal terminals and a grounding terminal.

4. The connector terminal structure as claimed in claim 1, wherein the soldered sections of the terminals of the first terminal set are not lined up and are soldered on the circuit board in multiple rows.

5. The connector terminal structure as claimed in claim 1, wherein the soldered sections of the terminals of the second terminal set are not lined up and are soldered on the circuit board in multiple rows.
